(19) United States
(12) Patent Application Publication
(10) Pub. No.: US 2012/0289648 A1
(43) Pub. Date: Nov. 15, 2012

(54) REACTIVE COMPOUNDS ON THE BASIS OF TRANSESTERIFICATION

(75) Inventors: Emmanouil Spyrou, Schermbeck (DE); Claudia Torre, Duesseldorf (DE); Marina Grammenos, Duesseldorf (DE); Elke Gollan, Herne (DE); Andrea Diesveld, Gescher (DE)

(73) Assignee: Evonik Degussa GmbH, Essen (DE)

(21) Appl. No.: 13/515,004

(22) PCT Filed: Nov. 2, 2010
(86) PCT No.: PCT/EP2010/066608

§ 371 Date: Jun. 11, 2012

(30) Foreign Application Priority Data
Dec. 11, 2009 (DE) 10 2009 054 560.3

(51) Int. Cl. C08L 33/14; C09J 133/14; C09D 133/14

(52) U.S. Cl. 524/558

(57) ABSTRACT

The invention relates to reactive compounds on the basis of transesterification, comprising A1) at least one dicarboxylic or polycarboxylic acid ester component comprising at least two or more ester groups, comprising at least one monofunctional alcohol having a mean molar mass Mn of less than or equal to 200 g/mol as the esterification component and A2) at least one diol or polyol component having at least two or more OH groups and/or B) at least one component carrying carboxylic acid ester groups, comprising at least one monofunctional alcohol having a mean molar mass Mn of less than or equal to 200 g/mol as the esterification component, and alcohol groups; and C) bismuth triflate as the catalyst; D) optionally further auxiliary agents.

The invention relates to reactive compositions on the basis of transesterification.

The reaction of carboxylic acids or carboxylic acid derivatives and alcohols to give carboxylic esters is one of the most commonly used reactions in organic chemistry. It therefore also plays a particular role in the coatings and adhesives industry. While it is usually used for production of coating or adhesive components (for example polyester resins), it can also be used as a curing reaction. This is possible particularly efficiently when activated acid derivatives are used, for example carboxylic esters. The reaction between polycarboxylic esters and polyols (transesterification) has already been described in patents U.S. Pat. No. 4,423,167, U.S. Pat. No. 4,397990, U.S. Pat. No. 4,332,711 and U.S. Pat. No. 4,897,450 as a crosslinking principle. The catalysts used were, for example, zinc acetate, lead silicate or zinc octoate. However, these catalysts had quite low reactivity, and so there was a search for more active substances, in particular for catalysts which have a favorable reactivity/storage stability relationship. Triflates of different metals (Li, Na, K, Ba, Mg, Ca, Al, In, Sn, Sc, Y, Ti, Zr, Fe, Cu, Ag or Zn) have already been described as transesterification catalysts (EP2113499). Here, however, there is a lack of use in reactive compositions for coatings and adhesives applications. For this purpose, in contrast, for example, diphenyl ammonium triflate has been proposed (Tetrahedron Letters 41 (2000) 5249-5252) and subsequently also registered (JP 2004 352 865). Nevertheless, even today there is still a need for catalysts for transesterification reactions which possess a more favorable relationship of reactivity and storage stability than conventional catalysts.

The objective was to find catalysts which make it possible to obtain simultaneously reactive but also storage-stable compositions of polycarboxylic esters and polyols.

It has been found that, surprisingly, bismuth triflate fulfills the objective.

The invention provides a reactive composition comprising

A1) at least one di- or polycarboxylic ester component having at least two or more ester groups containing at least one monofunctional alcohol having a mean molar mass Mn of less than or equal to 200 g/mol as the esterification component and

A2) at least one di- or polyol component having at least two or more OH groups and/or

B) at least one component which bears both carboxylic ester groups containing at least one monofunctional alcohol having a mean molar mass Mn of less than or equal to 200 g/mol as the esterification component, and alcohol groups; and

C) bismuth triflate as a catalyst;

D) optionally further assistants.

The invention accordingly provides reactive compositions composed of two components A1) and A2, or A1) and B, or A2) and B), or of the three components A1), A2) and B).

In the transesterification, the carboxylic ester moieties react with alcohol groups to eliminate the alcohol of the carboxylic ester group starting compound. This results in crosslinking of the starting materials. Particularly suitable carboxylic esters are those of lower alcohols, since the latter can be vaporized out of the coating or adhesive layer even at relatively low temperatures, and hence the equilibrium is shifted to the side of the crosslinked products.

Both the carboxylic ester groups and the alcohol groups may be present at any positions in the molecule. Preference is given, however, to the terminal positions in the reactive starting molecules.

Suitable components A1), A2) and/or B) are specified, for example, in U.S. Pat. No. 4,489,182, U.S. Pat. No. 4,362,847, U.S. Pat. No. 4,332,711, U.S. Pat. No. 4,37,848 and U.S. Pat. No. 4,459,393.

Possible components A1), A2) and/or B) include all monomers, oligomers or polymers which bear either ester groups or hydroxyl groups, or both groups. Suitable base structures for the oligomers and polymers are polyesters, polyacrylates, polyethers, polyurethanes, polycarbonates, polyamides and polyepoxides.

Suitable substances A1) containing monomeric ester groups are, for example, dimethyl succinate, dimethyl adipate, dimethyl glutarate, dimethyl sebacate, dimethyl isophthalate, dimethyl terephthalate, trimethyl 1,3,5-benzenetricarboxylate, dimethyl 1,4-cyclohexanedicarboxylate, trimethyl 1,3,5-cyclohexanetricarboxylate, and/or polymers having terminal carboxylic acid groups esterified with monofunctional alcohols having a mean molecular mass Mn of less than or equal to 200 g/mol, preferably with alcohols having 1-12 carbon atoms and aromatic compounds, for example methanol, ethanol, propanol, isopropanol, n-butanol, sec-butanol, tert-butanol or 2-butanol, aromatics such as phenol or benzyl alcohol. Preference is given to methanol, ethanol and n-butanol.

Likewise usable with preference as component A1) are (meth)acrylates and poly(meth)acrylates. They are prepared by the copolymerization of (meth)acrylates.

Such polymers are described in:
Special techniques for synthesis of high solid resins and applications in surface coatings. Chakrabarti, Suhas; Ray, Somnath., Berger Paints India Ltd., Howrah, India. Paintindia (2003), 53 (1), 33-34,36,38-40;
VOC protocols and high solid acrylic coatings. Chattopadhyay, Dipak K.; Narayan, Ramanuj; Raju, K. V. S. N. Organic Coatings and Polymers Division, Indian Institute of Chemical Technology, Hyderabad, India. Paintindia (2001), 51 (10), 31-42.

Acrylates are prepared by polymerization of monomers bearing methacrylate or acrylate groups and by copolymerization with further ethylenically unsaturated monomers, the free-radical polymerization of the double bonds being initiated by peroxides or azo components.

(Meth)acrylate-containing monomers for the preparation of Al) include alkyl esters of acrylic acid or methacrylic acid esterified with monofunctional alcohols having a mean molar mass Mn of less than or equal to 200 g/mol, preferably with alcohols having 1-12 carbon atoms and aromatic compounds, for example methanol, ethanol, propanol, isopropanol, n-butanol, sec-butanol, tert-butanol or 2-butanol, aromatics, for example phenol, or benzyl alcohol. Preference is given to methanol, ethanol or n-butanol.

The acid used is preferably acrylic acid and/or methacrylic acid. Examples of component A1), and also of starting components in the case of reaction with the comonomers specified below for A1), are methyl acrylate, methyl methacrylate, ethyl acrylate, ethyl methacrylate, propyl acrylate and propyl methacrylate, butyl acrylate and butyl methacrylate, acrylic acid ethylhexanoate and methacrylic acid ethylhexanoate, cyclohexyl acrylate and cyclohexyl methacrylate, benzyl acrylate, benzyl methacrylate, and various reaction products, for example, butyl, phenyl, and cresyl glycidyl ethers reacted with acrylic acid and methacrylic acid.

Comonomers containing polymerizable double bonds include monomers containing vinyl groups, monomers containing allyl groups and compounds bearing acrylamide groups, for example vinyl acetate, vinyl propionate, vinyl butyrate, vinyl benzoate, vinyl isopropyl acetates and similar vinyl esters; vinyl halides, for example vinyl chloride, vinyl fluoride, and vinylidene chlorides, styrene, methylstyrene and alkylstyrenes, chlorostyrene, vinyltoluene, vinylnaphthalene, vinyl benzoate and cyclohexene. These also include alpha-olefins, for example ethylene, propylene, isobutylene and cyclohexene, and also butadienes, methyl-2-butadiene, 1,3-piperylene, 2,3-dimethylbutadiene, isoprene, cyclopentadiene and dicyclopentadienes. Also methyl vinyl ether, isopropyl vinyl ether, butyl vinyl ether and isobutyl vinyl ether.

It is also possible to use polyurethanes containing ester groups as component Al). Such polyurethanes are prepared by the reaction of mono-, di- or polyols as the alcohol component, these simultaneously containing ester moiety, with di- or polyisocyanates. Suitable alcohol components are all monomeric, oligomeric or polymeric alcohols described (for example in this document under B)), provided that they have at least one ester moiety, esterified with monofunctional alcohols having a mean molar mass Mn of less than or equal to 200 g/mol, preferably with alcohols having 1-12 carbon atoms and aromatic compounds, for example methanol, ethanol, propanol, isopropanol, n-butanol, sec-butanol, tert-butanol or 2-butanol, aromatics, for example phenol or benzyl alcohol. Useful examples include glycolic esters, hydroxypropionic esters and hydroxybutanoic esters. Preference is also given to reaction products of lactones (e.g. epsilon-caprolactone) with low molecular weight monoalcohols, for example methanol, ethanol, propanol, isopropanol, n-butanol, sec-butanol, tert-butanol or 2-butanol. The formation of polylactones is described, for example, in Kowalski, A. et al. Macromolecules, 2000, 33, 689-695; Chem, H. L. et al. Organometallics, 2001, 23, 5076-5083; Cherdron, H. et al., Makromol. Chem. 1962, 56, 179; Basko, M. et al., J. Polym. Chem., 2006, 44, 7071-7081; Ritter, H. et al. Adv. Polym. Sci., 2006, 194, 95 or in DE 32 21 692. In the case of use of abovementioned monoalcohols as starter molecules, monoalcohols which additionally bear a carboxylic ester with a low molecular weight alcohol are formed. Such molecules are particularly suitable for forming polyurethane-containing molecules of category A1) in the reaction with isocyanate-containing components.

Suitable aromatic di- or polyisocyanates are in principle all known compounds. Particularly suitable compounds are phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,2′-diisocyanate (2,2′-MDI), diphenylmethane 2,4′-diisocyanate (2,4′-MDI), diphenylmethane 4,4′-diisocyanate (4,4′-MDI), the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene.

Suitable aliphatic di- or polyisocyanates advantageously have 3 to 16 carbon atoms, preferably 4 to 12 carbon atoms, in the linear or branched alkylene radical, and suitable cycloaliphatic or (cyclo)aliphatic diisocyanates advantageously 4 to 18 carbon atoms, preferably 6 to 15 carbon atoms, in the cycloalkylene radical. (Cyclo)aliphatic diisocyanates are sufficiently well understood by the person skilled in the art to mean simultaneously cyclically and aliphatically bonded NCO groups, as in the case, for example, for isophorone diisocyanate. In contrast, cycloaliphatic diisocyanates are understood to mean those which have only NCO groups bonded directly on the cycloaliphatic ring, for example H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate, dodecane di- and triisocyanates.

Preference is given to using isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethyl-hexamethylene diisocyanate (TMDI), norbornane diisocyanate (NBDI). Very particular preference is given to using IPDI, HDI, TMDI and/or H₁₂MDI, and the isocyanurates and uretdiones are also usable with preference.

Likewise suitable are 4-methylcyclohexane 1,3-diisocyanate, 2-butyl-2-ethyl-pentamethylene diisocyanate, 3(4)-isocyanatomethyl-1-methylcyclohexyl isocyanate, 2-isocyanatopropylcyclohexyl isocyanate, 2,4′-methylenbis(cyclohexyl) diisocyanate, 1,4-diisocyanato-4-methylpentane.

It will be appreciated that it is also possible to use mixtures of the di- and polyisocyanates.

The reaction of the alcohol component and of the isocyanate component for component A1) can be performed in suitable apparatuses, stirred tanks, static mixers, tubular reactors, kneaders, extruders or other reaction spaces with or without mixing function. The reaction is performed at temperatures between room temperature and 220° C., preferably between 40° C. and 120° C., and, according to the temperature and reaction components, takes between a few seconds and several weeks. Preference is given to a reaction time between 30 min and 24 h. The ratio between the NCO component and the alcohol component is, calculated as NCO/OH, 0.3:1 to 1.05:1, preferably 0.5:1 to 1:1.

The end product does not have any significant free NCO groups (<0.5% by weight).

For acceleration of the polyaddition reaction, the catalysts customary in PU chemistry can be used. They are used in a concentration of 0.001 to 2% by weight, preferably of 0.01 to 0.5% by weight, based on the reaction components used. Catalysts are, for example, tert-amines such as triethylamine, pyridine or N,N-dimethylamino-cyclohexane, or metal salts such as iron(III) chloride, molybdenum glycolate and zinc chloride. Particularly suitable catalysts have been found to be tin(II) and tin(IV) compounds. Particular mention should be made here of dibutyltin dilaurate (DBTL) and tin octoate.

The polyurethanes may be in solid, viscous, liquid or else pulverulent form.

The diols and polyols A2) used are, for example, ethylene glycol, 1,2-, 1,3-propanediol, diethylene glycol, dipropylene glycol, triethylene glycol, tetraethylene glycol, 1,2-, 1,4-butanediol, 1,3-butylethylpropanediol, 1,3-methyl-propanediol, 1,5-pentanediol, bis(1,4-hydroxymethyl)cyclohexane (cyclohexane dimethanol), glycerol, hexanediol, neopentyl glycol, trimethylolethane, trimethylolpropane, pentaerythritol, bisphenol A, bisphenol B, bisphenol C, bisphenol F, norbornylene glycol, 1,4-benzyldimethanol, 1,4-benzyldiethanol, 2,4-dimethyl-2-ethylhexane-1,3-diol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)-tricyclo[5.2.1.0^{2.6}]decane (dicidol), 2,2-bis-(4-hydroxycyclohexyl)propane, 2,2-bis-[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl) isocyanurate, mannitol, sorbitol, polypropylene glycols, polybutylene glycols, xylylene glycol, neopentyl glycol hydroxypivalate, hydroxyacrylates, alone or in mixtures.

Particularly preferred as A2) are 1,4-butanediol, 1,3-propanediol, cyclohexane-dimethanol, neopentyl glycol, decanediol, dodecanediol, trimethylolpropane, ethylene glycol, triethylene glycol, pentane-1,5-diol, hexane-1,6-diol, 3-methylpentane-1,5-diol, neopentyl glycol, 2,2,4(2,4,4)-trimethylhexanediol and neopentyl glycol hydroxypivalate. They are used alone or in mixtures. 1,4-Butanediol is used only in mixtures.

Suitable compounds A2) are also diols and polyols which contain further functional groups. These are preferably the linear or lightly branched polymers containing hydroxyl groups which are known per se and are selected from the group of the polyesters, polycarbonates, polycaprolactones, polyethers, polythioethers, polyesteramides, polyacrylates, polyvinyl alcohols, polyurethanes or polyacetals. They preferably have a number-average molecular weight of 134 to 20000 g/mol, more preferably 134-4000 g/mol. The OH number in the case of these polymers is between 5 and 500 mg KOH/g.

In the case of the polymers A2) containing hydroxyl groups, preference is given to polyesters, polyethers, polyacrylates, polyurethanes, polyvinyl alcohols and/or polycarbonates having an OH number of 5-500 mg KOH/gram.

Preferred as A2) are linear or lightly branched polyesters containing hydroxyl groups—polyester polyols—or mixtures of such polyesters. They are prepared, for example, by reaction of diols with deficiencies of dicarboxylic acids, corresponding dicarboxylic anhydrides, corresponding dicarboxylic esters of lower alcohols, lactones or hydroxycarboxylic acids.

Preference is given to using 1,4-butanediol, 1,2-propanediol, cyclohexanedimethanol, hexanediol, neopentyl glycol, decanediol, dodecanediol, trimethylolpropane, ethylene glycol, triethylene glycol, pentane-1,5-diol, hexane-1,6-diol, 3-methylpentane-1,5-diol, neopentyl glycol, 2,2,4(2,4,4)-trimethylhexanediol and neopentyl glycol hydroxypivalate for preparing of the polyester polyols.

Diols and polyols suitable for preparation of the preferred polyester polyols are, as well as the abovementioned diols and polyols, also 2-methylpropanediol, 2,2-dimethylpropanediol, diethylene glycol, dodecane-1,12-diol, 1,4-cyclohexane-dimethanol and 1,2- and 1,4-cyclohexanediol.

Dicarboxylic acids or derivatives suitable for preparation of the polyester polyols may be aliphatic, cycloaliphatic, aromatic and/or heteroaromatic in nature and may optionally be substituted, for example by halogen atoms, and/or unsaturated.

The preferred dicarboxylic acids or derivatives include succinic acid, adipic acid, suberic acid, azelaic acid and sebacic acid, 2,2,4(2,4,4)-trimethyladipic acid, phthalic acid, phthalic anhydride, isophthalic acid, terephthalic acid, dimethyl terephthalate, tetrahydrophthalic acid, maleic acid, maleic anhydride and dimeric fatty acids.

Suitable polyester polyols are also those which can be prepared in a known manner by ring opening from lactones, such as ε-caprolactone, and simple diols as starter molecules. It is also possible to use mono- and polyesters formed from lactones, e.g. ε-caprolactone, or hydroxycarboxylic acids, e.g. hydroxypivalic acid, ε-hydroxydecanoic acid, ε-hydroxycaproic acid, thioglycolic acid, as starting materials for the preparation of the polymers. Polyesters formed from the abovementioned polycarboxylic acids or derivatives thereof and polyphenols, hydroquinone, bisphenol A, 4,4′-dihydroxybiphenyl or bis(4-hydroxyphenyl) sulfone; polyesters of carbonic acid which are obtainable in a known manner from hydroquinone, diphenylolpropane, p-xylylene glycol, ethylene glycol, butanediol or hexane-1,6-diol and other polyols by customary condensation reactions, for example with phosgene or diethyl or diphenyl carbonate, or from cyclic carbonates such as glycol carbonate or vinylidene carbonate by polymerization; polyesters of silicic acid, polyesters of phosphoric acid, for example formed from methane-, ethane-, β-chloroethane-, benzene- or styrenephosphoric acid or derivatives thereof, for example phosphoryl chlorides or phosphoric esters and polyalcohols or polyphenols of the abovementioned type; polyesters of boric acid; polysiloxanes, for example the products obtainable by hydrolysis of dialkyldichlorosilanes with water and subsequent treatment with polyalcohols, those obtainable by addition of polysiloxane dihydrides onto olefins such as allyl alcohol or acrylic acid, are suitable as starting materials for the preparation of compounds A2).

The polyesters can be obtained in a manner known per se by condensation in an inert gas atmosphere at temperatures of 100 to 260° C., preferably 130 to 220° C., in the melt or in azeotropic mode, as described, for example, in Methoden der Organischen Chemie [Methods of Organic Chemistry] (Houben-Weyl); volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961.

The diols and dicarboxylic acids or derivatives thereof used for preparation of the polyester polyols can be used in any desired mixtures.

It is also possible to use mixtures of polyester polyols and diols.

Suitable compounds A2) are also the reaction products of polycarboxylic acids and glycide compounds, as described, for example, in DE-A 24 10 513.

Examples of glycidyl compounds which can be used are esters of 2,3-epoxy-1-propanol with monobasic acids having 4 to 18 carbon atoms, such as glycidyl palmitate, glycidyl laurate and glycidyl stearate, alkylene oxides having 4 to 18 carbon atoms, such as butylene oxide, and glycidyl ethers such as octyl glycidyl ether.

Suitable glycide compounds are also those which, as well as an epoxide group, also bear at least one further functional group, for example carboxyl, hydroxyl, mercapto or amino groups, which is capable of reaction with an isocyanate group.

It is also possible to use polyurethanes containing hydroxyl groups as component A2). Such polyurethanes are prepared by the reaction of polyols and di- or polyisocyanates. Suitable polyol components are all monomeric, oligomeric or polymeric polyols already described in this document.

Particular preference is given to 1,4-butanediol, 1,3-propanediol, cyclohexanedimethanol, neopentyl glycol, decanediol, dodecanediol, trimethylolpropane, ethylene glycol, triethylene glycol, pentane-1,5-diol, hexane-1,6-diol, 3-methylpentane-1,5-diol, neopentyl glycol, 2,2,4(2,4,4)-trimethylhexanediol and neopentyl glycol hydroxypivalate. They are used alone or in mixtures. 1,4-Butanediol is used only in mixtures.

Preference is likewise given to the above-described linear or lightly branched polyesters containing hydroxyl groups—polyester polyols—or mixtures of such polyesters.

Suitable aromatic di- or polyisocyanates are in principle all known compounds. Particularly suitable compounds are phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,4′-diisocyanate (2,4′-MDI), diphenylmethane 4,4′-diisocyanate, the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene

Suitable aliphatic di- or polyisocyanates advantageously have 3 to 16 carbon atoms, preferably 4 to 12 carbon atoms, in the linear or branched alkylene radical, and suitable cycloaliphatic or (cyclo)aliphatic diisocyanates advantageously 4 to 18 carbon atoms, preferably 6 to 15 carbon atoms, in the cycloalkylene radical. (Cyclo)aliphatic diisocyanates are sufficiently well understood by the person skilled in the art to mean simultaneously cyclically and aliphatically bonded NCO groups, as in the case, for example, for isophorone diisocyanate. In contrast, cycloaliphatic diisocyanates are understood to mean those which have only NCO groups bonded directly on the cycloaliphatic ring, for example H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate, dodecane di- and triisocyanates.

Preference is given to using isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Very particular preference is given to using IPDI, HDI, TMDI and/or H₁₂MDI, and the isocyanurates and uretdiones are also usable with preference.

Likewise suitable are 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenbis(cyclohexyl) diisocyanate, 1,4-diisocyanato-4-methylpentane.

It will be appreciated that it is also possible to use mixtures of the di- and polyisocyanates.

The reaction of the polyol component and of the isocyanate component for component A2) can be performed in suitable apparatuses, stirred tanks, static mixers, tubular reactors, kneaders, extruders or other reaction spaces with or without mixing function. The reaction is performed at temperatures between room temperature and 220° C., preferably between 40° C. and 120° C., and, according to the temperature and reaction components, takes between a few seconds and several weeks. Preference is given to a reaction time between 30 min and 24 h. The ratio between the NCO component and the alcohol component is, calculated as NCO/OH, 0.3:1 to 1.05:1, preferably 0.5:1 to 1:1.

The end product does not have any significant free NCO groups (<0.5% by weight). For acceleration of the polyaddition reaction, the catalysts customary in PU chemistry can be used. They are used in a concentration of 0.001 to 2% by weight, preferably of 0.01 to 0.5% by weight, based on the reaction components used. Catalysts are, for example, tert-amines such as triethylamine, pyridine or N,N-dimethylaminocyclohexane, or metal salts such as iron(III) chloride, molybdenum glycolate and zinc chloride. Particularly suitable catalysts have been found to be tin(II) and tin(IV) compounds. Particular mention should be made here of dibutyltin dilaurate (DBTL) and tin octoate.

The polyurethanes may be in solid, viscous, liquid or else pulverulent form.

It is possible to use any desired combinations of these compounds A2).

Usable components B) are compounds which contain OH groups and have ester groups, in which the ester-forming alcohol has a molar mass of not more than 200 g/mol. These include low molecular weight molecules, for example glycolic esters, hydroxypropionic esters and hydroxybutanoic esters, lactic esters, citric esters and/or tartaric esters, in which the acid groups have been esterified with monofunctional alcohols having a mean molar mass Mn of less than or equal to 200 g/mol, as already described in more detail above.

Useable components B) are (meth)acrylates and poly(meth)acrylates containing OH groups. They are prepared by the copolymerization of (meth)acrylates, where individual feedstocks bear OH groups but others do not. Thus, a randomly distributed polymer containing OH groups is obtained.

Such polymers are described in:
High solids hydroxy acrylics with tightly controlled molecular weight. van Leeuwen, Ben., SC Johnson Polymer, Neth. PPCJ, Polymers Paint Colour Journal (1997), 187 (4392), 11-13;
Special techniques for synthesis of high solid resins and applications in surface coatings. Chakrabarti, Suhas; Ray, Somnath., Berger Paints India Ltd., Howrah, India. Paintindia (2003), 53 (1), 33-34,36,38-40;
VOC protocols and high solid acrylic coatings. Chattopadhyay, Dipak K.; Narayan, Ramanuj; Raju, K. V. S. N. Organic Coatings and Polymers Division, Indian Institute of Chemical Technology, Hyderabad, India. Paintindia (2001), 51 (10), 31-42.

Acrylates are prepared by polymerization of monomers bearing methacrylate or acrylate groups and optionally by copolymerization with further ethylenically unsaturated monomers, the free-radical polymerization of the double bonds being initiated by peroxides or azo components.

Preferred (meth)acrylate-containing monomers include alkyl esters of acrylic acid or methacrylic acid esterified with monofunctional alcohols having a mean molar mass Mn of less than or equal to 200 g/mol, preferably with alcohols having 1 to 12 carbon atoms, and aromatic compounds, for example methanol, ethanol, propanol, isopropanol, n-butanol, sec-butanol, tert-butanol or 2-butanol, aromatics, for example phenol or benzyl alcohol. Preference is given to methanol, ethanol and n-butanol. The acids used are preferably acrylic acid and/or methacrylic acid. Examples of starting components for preparation of component B), optionally with the comonomers specified below, are methyl acrylate, methyl methacrylate, ethyl acrylate, ethyl methacrylate, propyl acrylate and propyl methacrylate, butyl acrylate and butyl methacrylate, acrylic acid ethylhexanoate and methacrylic acid ethylhexanoate, cyclohexyl acrylate and cyclohexyl methacrylate, benzyl acrylate, benzyl methacrylate and various reaction products, for example butyl, phenyl and cresyl glycidyl ethers reacted with acrylic acid and methacrylic acid.

Comonomers containing polymerizable double bonds include monomers containing vinyl groups, monomers containing allyl groups and compounds bearing acrylamide groups, for example vinyl acetate, vinyl propionate, vinyl butyrate, vinyl benzoate, vinyl isopropyl acetates and similar vinyl esters; vinyl halides, for example vinyl chloride, vinyl fluoride, and vinylidene chlorides, styrene, methylstyrene and alkylstyrenes, chlorostyrene, vinyltoluene, vinylnaphthalene, vinyl benzoate and cyclohexene. These also include alpha-olefins, for example ethylene, propylene, isobutylene and cyclohexene, and also butadienes, methyl-2-butadiene, 1,3-piperylene, 2,3-dimethylbutadiene, isoprene, cyclopentadiene and dicyclopentadienes. Also methyl vinyl ether, isopropyl vinyl ether, butyl vinyl ether and isobutyl vinyl ether.

The hydroxy-functional component B) bearing methacrylate or acrylate groups is prepared by copolymerization of specific hydroxylated monomers, for example 2-hydroxyethyl acrylate and 2-hydroxyethyl methacrylate, 2-hydroxypropyl acrylate and 2-hydroxypropyl methacrylate, hydroxybutyl acrylate and 2-hydroxybutyl methacrylate and similar hydroxyalkyl acrylates, with the abovementioned (meth)acrylates and poly(meth)acrylates. Polyacrylates bearing methacrylate or acrylate groups and containing hydroxyl groups are preferably used as component B). They are commercially available, for example, from NUPLEX under the SETALUX trade name, e.g. SETALUX 91770 VS 70 or SETALUX Cl 187XX60 or SETALUX 1770 VS60, and many others, and from Johnson Polymers under the JONCRYL name (e.g. JONCRYL 587), from BASF (SCX 804) and from Anderson (ALMATEX 2001).

It is also possible to use polyurethanes containing ester groups and containing hydroxyl groups as component B).

The isocyanate component is prepared by the reaction of mono-, di- and/or polyols with di- and polyisocyanates.

Suitable alcohol components are the monomeric, oligomeric or polymeric alcohols already described in this document for the formation of component Al) containing polyurethane groups, and the monomeric, oligomeric or polymeric alcohols for the formation of component A2) containing polyurethane groups.

Particular preference is given to 1,4-butanediol, 1,3-propanediol, cyclohexanedimethanol, neopentyl glycol, decanediol, dodecanediol, trimethylolpropane, ethylene glycol, triethylene glycol, pentane-1,5-diol, hexane-1,6-diol, 3-methylpentane-1,5-diol, neopentyl glycol, 2,2,4-trimethylhexanediol, 2,4,4-trimethylhexanediol and neopentyl glycol hydroxypivalate. They are used alone or in mixtures. 1,4-Butanediol is used only in mixtures.

Preference is likewise given to the above-described linear or lightly branched polyesters containing hydroxyl groups—polyester polyols—or mixtures of such polyesters.

Suitable aromatic di- or polyisocyanates are in principle all known compounds. Particularly suitable compounds are phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,4′-diisocyanate (2,4′-MDI), diphenylmethane 4,4′-diisocyanate, the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene.

Suitable aliphatic di- or polyisocyanates advantageously have 3 to 16 carbon atoms, preferably 4 to 12 carbon atoms, in the linear or branched alkylene radical, and suitable cycloaliphatic or (cyclo)aliphatic diisocyanates advantageously 4 to 18 carbon atoms, preferably 6 to 15 carbon atoms, in the cycloalkylene radical. (Cyclo)aliphatic diisocyanates are sufficiently well understood by the person skilled in the art to mean simultaneously cyclically and aliphatically bonded NCO groups, as in the case, for example, for isophorone diisocyanate. In contrast, cycloaliphatic diisocyanates are understood to mean those which have only NCO groups bonded directly on the cycloaliphatic ring, for example H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate, dodecane di- and triisocyanates.

Preference is given to using isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Very particular preference is given to using IPDI, HDI, TMDI and/or H₁₂MDI, and the isocyanurates and uretdiones are also usable with preference.

Likewise suitable are 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenbis(cyclohexyl) diisocyanate, 1,4-diisocyanato-4-methylpentane.

It will be appreciated that it is also possible to use mixtures of the di- and polyisocyanates.

The isocyanate component is reacted with at least one alcohol component containing ester groups, which has been esterified with monofunctional alcohols having a mean molar mass Mn of less than or equal to 200 g/mol, preferably with alcohols having 1-12 carbon atoms, and aromatic compounds, for example methanol, ethanol, propanol, isopropanol, n-butanol, sec-butanol, tert-butanol, or 2-butanol, aromatics, for example phenol or benzyl alcohol. Preference is given to methanol, ethanol and n-butanol.

The isocyanate component can additionally also be reacted with at least one alcohol component free of ester groups.

The reaction of the alcohol components and of the isocyanate component to give component B) can be performed in suitable apparatuses, stirred tanks, static mixers, tubular reactors, kneaders, extruders or other reaction spaces with or without mixing function. The ratio between alcohols containing ester groups and alcohols free of ester groups may be between 1:20 and 20:1, preference being given to a ratio of between 1:5 and 5:1, more preferably between 1:2 and 2:1.

The reaction is performed at temperatures between room temperature and 220° C., preferably between 40° C. and 120° C., and according to the temperature and reaction components, takes between a few seconds and several weeks. Preference is given to a reaction time between 30 min and 24 h. The ratio between the NCO component and the alcohol components is, calculated as NCO/OH, 0.3:1 to 1.05:1, preferably 0.5:1 to 1:1.

The end product does not have any significant free NCO groups (<0.5% by weight). To accelerate the polyaddition reaction, the catalysts customary in PU chemistry can be used. They are used in a concentration of 0.001 to 2% by weight, preferably of 0.01 to 0.5% by weight, based on the reaction components used. Catalysts are, for example, tert-amines such as triethylamine, pyridine or N,N-dimethylaminocyclohexane, or metal salts such as iron(III) chloride, molybdenum glycolate and zinc chloride. Particularly suitable catalysts have been found to be tin(II) and tin(IV) compounds. These particularly include dibutyltin dilaurate (DBTL) and tin octoate.

The polyurethanes may be in solid, viscous, liquid and also pulverulent form.

As catalyst C, the reactive compositions comprise bismuth triflate. “Triflate” is the standard abbreviation for salts of trifluoromethylsulfonic acid. The empirical formula of the catalyst is Bi(F₃CSO₃)₃. It is used in amounts of 0.01 to 2% by weight, based on the overall formulation, preferably in 0.1 to 1% by weight.

In addition, the reactive compositions may also comprise assistants and additives D), selected from inhibitors, organic solvents optionally containing unsaturated moieties, interface-active substances, oxygen and/or free-radical scavengers, catalysts, light stabilizers, color brighteners, photoinitiators, photosensitizers, thixotropic agents, antiskinning agents, defoamers, dyes, pigments, fillers and matting agents. The amount varies significantly by field of use and type of assistant and additive.

Useful organic solvents include all liquid substances which do not react with other ingredients, for example acetone, xylene, Solvesso 100, Solvesso 150, dioxane, DMF.

It is likewise possible to add the customary additives D), such as leveling agents, for example polysilicones or acrylates, light stabilizers, for example sterically hindered amines, or other assistants as described, for example, in EP 0 669 353, in a total amount of 0.05 to 5% by weight. Fillers and pigments, for example titanium dioxide, can be added in an amount of up to 50% by weight of the overall composition. The equivalents ratio between alcohol groups and ester groups in the reactive composition of at least two or else three components may be between 1:20 and 20:1, preference being given to a ratio between 1:5 and 5:1, more preferably between 1:2 and 2:1. The components of the inventive reactive composition can be mixed in suitable apparatuses without solvent or in inert solvents (e.g. aliphatic or aromatic hydrocarbons, water) and be processed in liquid form or in solid form (as powder).

The inventive reactive compositions are storage-stable.

A reactive composition is considered to be storage-stable when the viscosity rise at 40° C. is not more than twice as high as the original rise within 4 weeks. The reactivity is measured in a comparative manner. For this purpose, for a given curing temperature and curing time, curing must be complete. The flexibility (Erichsen cupping>5 mm, direct ball impact>80 inch*lbs) must be sufficient and the chemical resistance (MEK test>100 double strokes) must be adequate. Moreover, the films must not be tacky.

The invention also provides a process for transesterifying a reactive composition comprising

A1) at least one di- or polycarboxylic ester component having at least two or more ester groups containing at least one monofunctional alcohol having a mean molar mass Mn of less than or equal to 200 g/mol as the esterification component

and

A2) at least one di- or polyol component having at least two or more OH groups and/or

B) at least one component which bears both carboxylic ester groups containing at least one monofunctional alcohol having a mean molar mass Mn of less than or equal to 200 g/mol as the esterification component, and alcohol groups;

in the presence of

C) bismuth triflate as a catalyst;

and

D) optionally further assistants.

The reactive composition can be used as a coating, as an adhesive or as a sealant. It is applied to the substrate in a suitable manner (spraying, rolling, painting, casting, flow coating, knife coating or the like).

It is cured for between 30 seconds and 24 hours, preferably between 3 min and 3 h. The curing temperature is between room temperature and 240° C., preferably between 80° C. and 200° C.

The invention is to be illustrated, but not restricted, hereinafter by examples.

### EXAMPLES

| Feed stocks | Product description, manufacturer |
|---|---|
| Trifluoromethylsulfonic acid | Aldrich |
| Diphenylamine | Aldrich |
| Bismuth triflate | Aldrich |
| SETALUX C1187XX60 | Acrylate containing OH groups and ester |
| | groups (Nuplex) 60% by weight in xylene |
| Tego ®Glide 410 | leveling aid, Evonik |

### A) Preparation of Diphenylammonium Triflate (DPAT) (Tetrahedron Letters 41 (2000) 5249-5252)

8.5 g of diphenylamine are dissolved in 100 ml of toluene and admixed at room temperature with 7.5 g of trifluoromethylsulfonic acid. After stirring for 15 min, the solvent is drawn off under reduced pressure, and the remaining residue is washed with 100 ml of hexane. After drying in a vacuum drying cabinet, 15.5 g of a colorless crystalline material are obtained (m.p. 170-172° C.).

### B) General Production And Application of Reactive Compositions 1 And Comparative Experiment 2

About 100 g mixtures were produced from 99.4 g of Setalux C1187XX60, 0.5 g of bismuth triflate (experiment 1) or DPAT (experiment 2) catalyst and 0.1 g of TegoGlide 410. For this purpose, the catalysts were dissolved in a little DMF. Thereafter, these compositions were painted with a 50 pm coating bar onto non-pretreated steel sheets (R36, Q-panel) and cured in an oven at 120° C. for 30 min or at 150° C. for 30 min. In addition, an initial viscosity and a viscosity at 40° C. after 28 days were measured for both reactive compositions.

TABLE 1

| No. | 1a | 1b | 2a* | 2b* |
|---|---|---|---|---|
| Catalyst | bismuth | bismuth | DPAT | DPAT |
| | triflate | triflate | | |
| Curing | 30 min | 30 min | 30 min | 30 min |
| | 130° C. | 150° C. | 130° C. | 150° C. |
| Layer | 19-27 | 13-17 | — | 13-21 |
| thickness [μm] | | | | |
| Erichsen | 6.5 | 8.5 | — | 10 |
| cupping [mm] | | | | |
| Direct/indirect | >80/>80 | >80/>80 | — | 40/20 |
| ball impact | | | | |
| [inch*lbs] | | | | |
| MEK Test | 40 | >100 | — | 80 |
| (double | | | | |
| strokes) | | | | |
| Comment | Film partly | Film cured | Film tacky, | Film slightly |
| | cured, not | | not cured! | tacky, partly |
| | tacky! | | | cured |

*noninventive comparative experiments
Erichsen cupping to DIN 53 156
Ball impact to ASTM D 2794-93
MEK test: methyl ethyl ketone stability test by rubbing with a cotton wool pad soaked in MEK with applied weight 1 kg until dissolution of the layer (double strokes are counted).

Composition 1b is fully cured: flexibility (Erichsen cupping>5 mm, direct ball impact>80 inch*lbs) is sufficient and chemical resistance (MEK test>100 double strokes) adequate. Moreover, the films of experiments 1a and 1b are not tacky. The films of experiments 2 (noninventive) are tacky. These are not (completely) cured.

Storage stability (rise in viscosity after 11 and 28 days (d) at 40° C. under 100%)

TABLE 2

| | Viscosity at 23° C. after storage in | | | |
|---|---|---|---|---|
| | a force air drying cabinet [mPas] | | | |
| No.: | Start | 11 d 40° C. | 28 d 40° C. | Rise compared to start |
| 1 | 329 | 390 | 463 | 29% |
| 2* | 363 | 1423 | solid | n.m. |

*noninventive comparative test

Only composition 1 is both reactive and storage-stable.

1. A reactive composition, comprising:
A1) at least one of a dicarboxylic ester and a polycarboxylic ester component comprising at least two or more ester groups comprising a monofunctional alcohol having a mean molar mass Mn of less than or equal to 200 g/mol;
and
A2) at least one of a diol and polyol component comprising at least two OH groups
and/or
B) a component which bears both i) carboxylic ester groups comprising a monofunctional alcohol having a mean molar mass Mn of less than or equal to 200 g/mol and ii) alcohol groups;
and
C) a catalyst comprising bismuth triflate;
and
D) optionally, a further assistant.

2. The reactive composition of claim 1, wherein the monofunctional alcohol is at least one selected from the group consisting of an alcohol comprising 1-12 carbon atoms and an alcohol comprising an aromatic moiety.

3. The reactive composition of claim 1, wherein component A1) comprises at least one selected from the group consisting of dimethyl succinate, dimethyl adipate, dimethyl glutarate, dimethyl sebacate, dimethyl isophthalate, dimethyl terephthalate, trimethyl 1,3,5-benzenetricarboxylate, dimethyl 1,4-cyclohexanedicarboxylat; and trimethyl 1,3,5-cyclohexanetricarboxylate.

4. The reactive composition of claim 1, wherein component A1) comprises a (meth)acrylate and a poly(meth)acrylate.

5. The reactive composition claim 4, wherein component A1) comprises at least one selected from the group consisting of methyl acrylate, methyl methacrylate, ethyl acrylate, ethyl methacrylate, propyl acrylate, propyl methacrylate, butyl acrylate, butyl methacrylate, acrylic acid ethylhexanoate, methacrylic acid ethylhexanoate, cyclohexyl acrylate, cyclohexyl methacrylate, benzyl acrylate, benzyl methacrylate, and a reaction product obtained by reacting a glycidyl ether with at least one selected from the group consisting of acrylic acid and methacrylic acid.

6. The reactive composition of claim 1, wherein component A1) comprises a polyurethane comprising ester groups.

7. The reactive composition claim 6, wherein the polyurethane comprises, in reacted form, at least one selected from the group consisting of isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), and norbornane diisocyanate (NBDI) and optionally, an isocyanurate and a uretdione.

8. The reactive composition of claim 1, wherein component A2) comprises at least one selected from the group consisting of ethylene glycol, 1,2-propanediol, 1,3-propanediol, diethylene glycol, dipropylene glycol, triethylene glycol, tetraethylene glycol, 1,2-butanediol, 1,4-butanediol, 1,3-butylethylpropanediol, 1,3-methylpropanediol, 1,5-pentanediol, bis(1,4-hydroxymethyl)cyclohexane, glycerol, hexanediol, neopentyl glycol, trimethylolethane, trimethylolpropane, pentaerythritol, bisphenol A, bisphenol B, bisphenol C, bisphenol F, norbornylene glycol, 1,4-benzyldimethanol, 1,4-benzyldiethanol, 2,4-dimethyl-2-ethylhexane-1,3-diol, 1,4-butylene glycol, 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)-tricyclo[5.2.1.0^{2.6}]decane (dicidol), 2,2-bis-(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl) isocyanurate, mannitol, sorbitol, a polypropylene glycol, a polybutylene glycol, xylylene glycol, neopentyl glycol hydroxypivalate, and a hydroxyacrylate.

9. The reactive composition of claim 1, wherein component A2) comprises a linear or lightly branched polymer comprising a hydroxyl group selected from the group consisting of a polyester, a polycarbonate, a polycaprolactone, a polyether, a polythioether, a polyesteramide, a polyacrylate, a polyvinyl alcohol, a polyurethane, and a polyacetal.

10. The reactive composition of claim 9, wherein component A2) is present and comprises a linear or lightly branched polyester comprising hydroxyl groups.

11. The reactive composition claim 1, wherein component A2) comprises a polyurethane comprising hydroxyl groups.

12. The reactive composition of claim 11, wherein the polyurethane comprises, in reacted form, at least one selected from the group consisting of isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), and norbornane diisocyanate (NBDI) and optionally, an isocyanurate and a uretdione.

13. The reactive composition of claim 1, wherein component B) comprises a compound comprising OH groups and ester groups.

14. The reactive composition claim 1, wherein component B) comprises at least one selected from the group consisting of a (meth)acrylate and a poly(meth)acrylate comprising OH groups.

15. The reactive composition of claim 14, wherein component B) comprises, in reacted form, at least one selected from the group consisting of methyl acrylate, methyl methacrylate, ethyl acrylate, ethyl methacrylate, propyl acrylate, propyl methacrylate, butyl acrylate, butyl methacrylate, acrylic acid ethylhexanoate, methacrylic acid ethylhexanoate, cyclohexyl acrylate, cyclohexyl methacrylate, benzyl acrylate, benzyl methacrylate, a reaction product obtained by reacting a glycidyl ether with at least one selected from the group consisting of acrylic acid and methacrylic acid, a hydroxyacrylate, and a hvdroxylmethacrylate.

16. The reactive composition of claim 1, wherein component B) comprises a polyurethane comprising ester groups and hydroxyl groups.

17. The reactive composition claim 16, wherein component B) comprises, in reacted form, at least one selected from the group consisting of isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), and norbornane diisocyanate (NBDI), and optionally an isocyanurate and uretdione.

18. The reactive composition of claim 1, wherein a content of the catalyst C) in the composition is 0.01 to 2% by weight, based on a total weight of the composition.
